(19) United States
(12) Patent Application Publication
(10) Pub. No.: US 2008/0094228 A1
(43) Pub. Date: Apr. 24, 2008

(54) PATIENT MONITOR USING RADIO FREQUENCY IDENTIFICATION TAGS

(76) Inventors: James P. Welch, Mission Viejo, CA (US); Gene Mason, La Habra Heights, CA (US); Massi E. Kiani, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/871,700

(22) Filed: Oct. 12, 2007

Related U.S. Application Data
(60) Provisional application No. 60/851,160, filed on Oct. 12, 2006.

(51) Int. Cl. G08B 23/00

(52) U.S. Cl. 340/573.1

(57) ABSTRACT

One aspect of the disclosure is to provide a patient monitoring system including a radio frequency identification (RFID) tag. The system comprises a patient monitor capable of communicating with the RFID tag. The RFID tag may advantageously store information useful in hospital environments, triage or disaster environments, home care environments, or the like. In some embodiments, the RFID tags may be provided as parts of wrist bands, dog tags, disposable sensor components, sensors or the like that are left with a patient.

### PRIORITY CLAIM

This application claims priority to U.S. Provisional Application No. 60/851,160, titled “Patient Monitor Using Radio Frequency Identification Tags” and filed on Oct. 12, 2006, the disclosure of which is incorporated herein by reference.

### BACKGROUND

1. Field of the Disclosure

The present disclosure relates in general to the use of radio frequency tags and more specifically to their use in patient monitors, such as oximeter systems.

2. Description of the Related Art

Quick diagnoses and efficient care for patients in trauma situations are often key to the survival of those patients. Perhaps, nowhere is this more clear than in large scale triage scenarios, such as can be brought about by natural disasters, industrial accidents, terrorist attacks, and wars. In these situations, doctors and other medical workers must utilize a limited amount of resources to assess, track, manage, and treat as many patients as possible. One important key to successful triage is efficient management of manpower and time with a minimum of duplicative steps. Another key is gathering information and keeping it readily available for those who make diagnoses and treat patients.

Some of the information that may be vital to diagnosing and treating patients includes body temperature, pulse rate, blood oxygen saturation, other vital signs, blood parameters, respiratory parameters, cardiac parameters or the like. Patient monitors, such as pulse oximeters, are proven noninvasive methods of gathering some or all of the foregoing vital signs. In general, patient care workers attach a non- or minimally-invasive sensor to a patient to acquire signals indicative of some or all of the foregoing physiological parameters.

In the case of a pulse oximeter, a sensor generally comprises one or more energy emission devices and one or more energy detection devices. Exemplary pulse oximeter patient monitors are commercially available from Masimo Corporation of Irvine, Calif. Moreover, exemplary monitors and sensors are disclosed in U.S. Pat. Nos. 5,758,644, 6,584,336, 6,157,850, and 6,377,829.

In some situations, such as disaster or combat, the monitoring of patients is generally accomplished by monitoring a patient for a short time, recording the results, and moving the monitor to the next patient where the process is repeated. Treating physicians may then see the recorded results or the actual monitoring. However, there are drawbacks associated with this method of triage. For example, recordings can get lost or damaged in the confusion of the situation or during movement of a patient from one location to another. Recordings can also be mislabeled or associated with the wrong patient. Such drawbacks often create a need to duplicate previously taken readings and loses at least some trending data that otherwise may have been available.

One solution of monitor manufacturers includes European “smart cards.” These cards have a variety of uses but may contain updatable medical histories of patients. While implementation of an automatic update may prevent human error in recording readings, smart cards are still not ideal for triage of mass casualty situations. Smart cards can be easily lost, dropped, or misplaced in the confusion of disaster relief and patient transport. Smart cards also often utilize a contact pad for interaction with the card's underlying microprocessor. Such contacts are susceptible to spoilage from dirt and damage. Moreover, often the card uses physical contact with a card reader to store or retrieve any information.

There is therefore a need for a system and device that allows for quick, reliable storage and retrieval of patient data.

### SUMMARY OF THE DISCLOSURE

Accordingly, one aspect of an embodiment of the disclosure is to provide a radio frequency identification (RFID) tag capable of storing and broadcasting patient information. The RFID tag includes an antenna and an information element for storing data. In an embodiment, the antenna receives a radio frequency signal which induces a current sufficient to access the information element and broadcast a response indicative of data stored on the information element. In an embodiment, the memory accessing and communication is aided by an included power source, such as a battery. In an embodiment, the RFID tag may be provided as a part of a wrist band, such as a patient ID tag, or a part of a dog tag or other semi-securable device (such as a clip, pin, sticker, article of clothing, necklace, jewelry, watch, ring or the like) that may be left with and at least semi-securely attached to a patient.

A further aspect of an embodiment of this disclosure is to provide a patient monitor capable of wirelessly communicating with such a RFID tag to retrieve patient data and in some embodiments, store data indicative of physiological or other parameters of the patient.

An embodiment of this disclosure also provides a RFID reader that can wirelessly retrieve the information stored on the RFID tag and display the retrieved data utilizing a stripped down or partial patient monitor.

Moreover, embodiments utilizing wireless communications reduce drawbacks with contact-based information transfer, such as from dust, water, bodily fluids, or any of a number of other contaminants that may affect transmissions over physical connections. In addition, wireless transmission of data is advantageous for busy physicians, nurses, medical technicians, or the like, who no longer spend time or effort searching for a chart, an electronic card, or even dog tags or ID bracelets on a patient. In an embodiment, merely bringing the RFID reader in proximity to a patient allows the transfer of data.

A further advantage of an embodiment of this disclosure includes the ability to store acquired patient identification data on the RFID tag, thereby advantageously allowing caregivers or others to find specific individuals, ensure that the tags are associated with the correct patients, or the like.

Yet another advantage of an embodiment of this disclosure is the ability to transport patients with less risk of losing potentially valuable readings of a patient's physiological parameters. This may be helpful in transporting patients from the site of a disaster area to a hospital, for example. It may also be helpful in transferring patients from one hospital to another, from one area of a hospital to another, or one triage area to another.

For purposes of summarizing the disclosure, certain aspects, advantages and novel features of the disclosure have been described herein. Of course, it is to be understood that not necessarily all such aspects, advantages or features will be embodied in any particular embodiment of the disclosure.

### BRIEF DESCRIPTION OF THE DRAWINGS

The following drawings and the associated descriptions are provided to illustrate embodiments of the present disclosure and do not limit the scope of the claims.

FIG. 1 illustrates an exemplary block diagram of an embodiment of a system patient monitor.

FIG. 2 illustrates a perspective view of an embodiment of the RFID tag.

FIG. 3 illustrates an exemplary planar view of an embodiment of the RFID bracelet.

FIG. 4 illustrates a block diagram of an embodiment of the RFID tag reading device.

### DETAILED DESCRIPTION

A patient monitor, such as a pulse oximeter, generally comprises a sensor component and a processing component that processes signals received from the sensor component. In an embodiment, the monitor displays physiological data in some format, such as on an electronic display. In situations when it is impossible or impractical to utilize a patient monitor to monitor one patient. It is advantageous to store patient data and/or some or all sensor data, processed data, trend data, encoded data of any or all of the foregoing, or the like for later reading or updating. Accordingly, an embodiment of the disclosure comprises a patient monitoring system including a sensor, a processing unit, and the RFID tag. The RFID tag comprises an information element, such as an integrated circuit, coupled with an antenna. In an embodiment, the processing unit communicates with an antenna capable of broadcasting and/or receiving electromagnetic signals. The patient monitoring system may broadcast signals indicative of any or all of the foregoing data. These broadcasts may be received by an antenna component of the RFID tag and stored in an information element. In an embodiment, the RFID tag may also respond to signals by broadcasting a signal of its own indicative of some or all of the data stored on the information element.

The antenna receives signals from a reader. The incoming radio frequency may also induce sufficient electrical current to power the information element and transmit a response indicative of some or all of the information stored on the information element. Such information may indicate patient identification (such as, for example, patient ID and/or other useful information, such as, name, birthday, social security number, race, hair and eye color, clothing being worn, extent of injury, and the like), patient type (such as, for example, adult, neonatal, nature or extent of injury, and the like), stored data regarding prior physiological readings (such as, for example, raw received data, processed data, output measurement trend data, and the like), or other useful or desired data (such as location or the like). The RFID tags may include passive RFID tags, active RFID tags, and the like. Passive RFID tags should be given broad ordinary meaning and generally include the RFID tags that are powered by the current induced from the antenna's reception of electromagnetic signals. Active RFID tags should also be given broad ordinary meaning and generally include the RFID tags that utilize a power source apart from or in addition to induction, such as, for example, a battery, a solar cell, or any of a number of other power sources, combinations of the same, or the like.

Although embodiments of this disclosure include oximeter systems, a skilled artisan would recognize from the disclosure herein that a wide range of patient monitoring devices are similarly within the scope of the disclosure.

To facilitate a complete understanding of the disclosure, the remainder of the detailed description describes the disclosure with reference to the drawings.

Patient Monitor

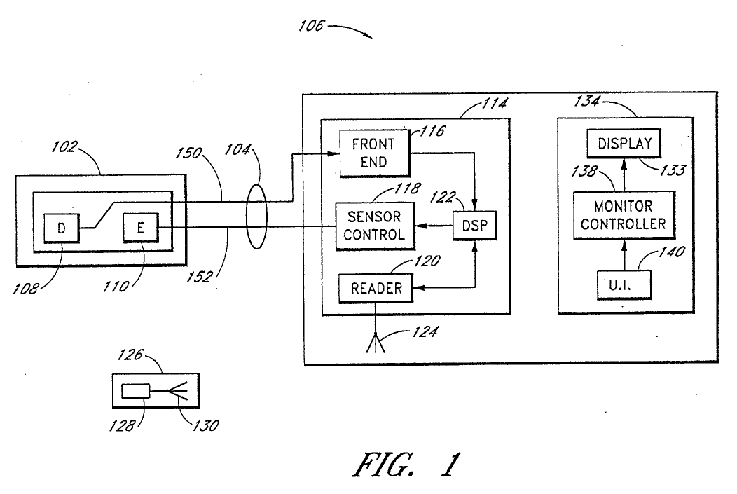

FIG. 1 presents an exemplary block diagram of an embodiment of a patient monitoring system 100, such as an oximeter system. As shown, the patient monitoring system 100 includes a sensor 102, cable 104, and a patient monitor 106, such as an oximeter. The sensor 102 generally comprises those elements designed to interact with circuitry components of the patient monitor and preferably comprises minimally invasive components, noninvasive components, and/or combinations of the same and the like. In the embodiment of an oximeter patient monitor, the sensor 102 includes one or more emitters 110 for irradiating body tissue and one or more detectors 108 capable of detecting the radiation after attenuation by body tissue. The sensor 102 also includes a plurality of conductors communicating signals to and from its components including emitter drive signal conductor 152 and detector composite signal conductor 150. According to an embodiment, the signal conductors 150, 152 communicate their signals to the patient monitor 106 through cable 104. The sensor 102 may also include an information element, a temperature indicator, processing circuitry, or the like. The sensor 102 may comprise disposable, reusable, or combination sensors, and include adult, pediatric, specialty care sensors, or the like.

Although disclosed with reference to the cable 104, a skilled artisan will recognize from the disclosure herein that the communication to and from the sensor 102 may advantageously include a wide variety of cables, cable designs, public or private communication networks, computer systems, wired or wireless communications, combinations of the same or the like.

FIG. 1 also shows the oximeter patient monitor 106 comprising one or more processing boards 114 communicating with one or more display units 124. According to an embodiment, the processing board 114 comprises processing circuitry arranged on one or more printed circuit boards capable of being distributed as an OEM component for a wide variety of patient monitoring devices. As shown in FIG. 1, the board 114 includes a front end signal conditioner 116 including an input from detector composite signal conductor 150 and an output communicating with a digital signal processor 122. In an embodiment, the processor 122 controls the drive signal of the emitters 110 through a sensor controller 118, which drives the emitters 110 over conductors 152.

The processing board 114 also includes a reader 120. In an embodiment, the reader 120 is capable of broadcasting a radio frequency signal through a monitor antenna 124 to communicate with a plurality of RFID tags, including, the RFID tag 126. Other alternatives are also contemplated by this disclosure, such as, for example, the location of reader 120. While reader 120 is a part of the processing board 114 in FIG. 1, reader 120 may also be placed on or near the sensor 102 in some embodiments. Such a placement may position the reader 120 closer to a patient's RFID tag 126, which in turn, may allow for communications consuming less power.

An embodiment of the RFID tag 126 comprises an information element 128 connected to an antenna 130. The information element 128 may be provided through an active circuit such as a transistor network, memory chip, EEPROM (electronically erasable programmable read-only memory), EPROM (erasable programmable read-only memory), or other identification device, such as multi-contact single wire memory devices or other devices commercially available from, for example, Dallas Semiconductor or Analog Devices. The antenna 130 receives signals broadcast from monitor antenna 124. In an embodiment, the signal directs information element 128 to broadcast a signal indicative of data stored thereon, and a signal is sent back to monitor antenna 124 through the tag antenna 130. In an embodiment, the signal received from monitor antenna 124 may direct the storage of data on information element 128. A reply signal indicating success or failure of such storage may also be sent. In an embodiment, reply signals from the RFID tag 126 may be accomplished through backscattering the patient monitor 106's original signal.

In an embodiment, display unit 124 communicates with the digital signal processor 122 to receive information for display, including for example, signals indicative of the data stored on the RFID tag 126 and retrieved by reader 120. The display unit 124 includes one or more displays 136 capable of displaying a wide variety of indicia representative of the calculated physiological parameters of the tissue at the measurement site. Such display devices may be controlled by monitor controller 138 that accepts signals from processor 122 and converts them for display. In an embodiment, monitor controller 138 may also accept signals from user interface 140. Monitor controller 138 may configure the information on display 136 according to user input from user interface 140 and signals from processor 122.

In an embodiment, user interface 140 may also be used to input patient data or notes for storage on the RFID tag 126. In such a case, monitor controller can communicate such input to digital signal processor 122. Digital signal processor 122 in turn communicates with the data to reader 120, which broadcasts it to the RFID tag 126 via monitor antenna 124. ID antenna 130 receives the signal and information element 128 stores the data for later retrieval.

In an embodiment, display unit 124 may also include audio or visual alarms that alert caregivers that one or more physiological parameters are falling below predetermined safe thresholds and may include indications of the confidence a caregiver should have in the display data.

Tags

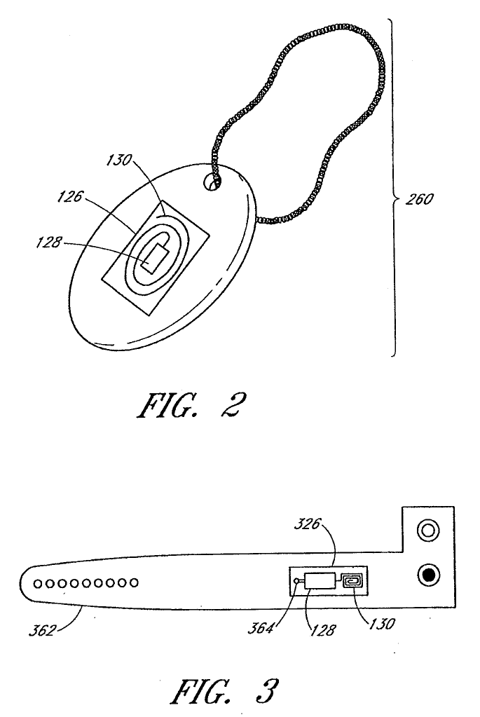

FIGS. 2 and 3 illustrate exemplary embodiments of the RFID tag 126. As shown in FIG. 2, the RFID tag 126 may be located on or embedded in a dog tag 260. The dog tag 260 can be worn around the neck of a patient or otherwise fastened to the patient or patient's clothing to reduce the likelihood of it being lost or misplaced. As pictured in FIG. 2, the RFID tag 126 may comprise the information element 128 and the tag antenna 130. As shown in FIG. 3, the RFID tag 326 may advantageously comprise an ID bracelet 362 that can be placed around a patient's or user's wrist or ankle. In FIG. 3, the RFID tag 126 comprises information element 128, ID antenna 130, and power source 364. Power source 364 may comprise a battery, solar cell, or any of a number or combination of other power sources, or the like. While FIGS. 2 and 3 represent two embodiments of the RFID tag 126, the disclosure is not be limited thereby. One of skill in the art would comprehend from the disclosure herein that a myriad of possibilities exist for wearable or body-attachable RFID tags. For example, the dog tag 260 may or may not include the power source 364; similarly, the bracelet 362 may not include a power source other than the antenna. Tags such as the dog tag 260 and bracelet 362 may be placed in a bracelet, anklet, necklace, arm band, wrist band, adhesive patch, cloth bandage, and the like.

In addition, patient monitors, such as pulse oximeters, often utilize reusable and disposable portions of their sensors, wherein the disposable portion attaches, often by tape to a patient's finger. As such, it is contemplated that a disposable sensor tape may contain the RFID tag disclosed by the present invention. The disposable tape may be left with the patient for straightforward attachment and detachment of the sensor for monitoring, and the appropriate RFID tag may store the data gathered by the sensor each time monitoring is undertaken.

Reader

In order to aid in review of patient data and diagnosis, it may be helpful to allow devices other than the patient monitor 100 to communicate with the RFID tag 126. In this way, medical technicians may advantageously utilize a small number of perhaps expensive, sensitive, and complicated monitors 100 to take patient readings, while doctors make rounds of the patients utilizing devices—that may be smaller and less expensive—to read the previously taken measurements, diagnose patients, and possibly update care instructions on how to proceed or what steps have been taken. PDAs, tablet PCs, smart phones, laptops, a myriad of handheld or portable computing devices, and the like may all be utilized as readers and/or writers to the tags 126.

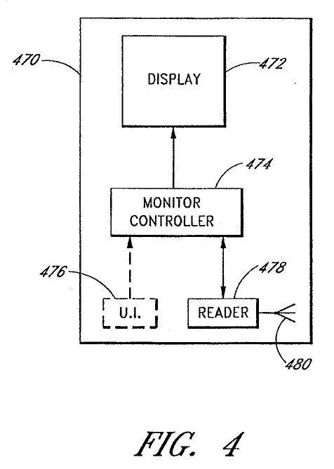

FIG. 4 illustrates an exemplary block diagram of an embodiment of a tag reader 470. The tag reader 470 comprises a display 472, monitor controller 474, user interface 476, and a reader 478 having a reader antenna 480. Reader 478 communicates with reader antenna 480 to broadcast signals and receive replies from the RFID tag 126. The reader 478 communicates with the monitor controller 474, which may interpret or process data and output information for display. In an embodiment, the user interface 476 may be utilized to configure data shown on the display 472. The monitor controller 474 configures what is shown on display 472. In an embodiment, a user interface may also be used to add data (such as, for example, diagnosis, care instructions, medications given, patient identifying information, and the like) to the RFID tag 126. Data input using the user interface 476 may be communicated to the reader 478 through the monitor controller 474. The reader 478 broadcasts the data using reader antenna 480 to the RFID tag 126.

Multiple devices such as the patient monitor 106 and the reader 470 may display data from the RFID tags 126 and often may write data to the RFID tags 126. Accordingly, the system may advantageously account for the integrity of any data stored on the RFID tag 126. In an embodiment, the data stored in information element 128 on the RFID tag 126 may be encrypted. In turn, the readers 120 and 470 may be configured to decrypt/encrypt data. In embodiments, encryption algorithms may advantageously encrypt information stored on information element 128, and/or encrypt the communication between the RFID tag 126 and patient monitor 106 or tag reader 470. A skilled artisan will recognize from the disclosure herein that a wide variety of simple or complex encryption algorithms, paradigms, methodologies, or a combination of the same executing on the patient monitor 106, the tag 126, or a combination of both, could be used to further ensure secure data. Examples can include the use of translation tables, symmetric or asymmetric key-based encryption methods, or many other encryption techniques or combinations known to an artisan of ordinary skill.

Selected Alternatives

Although the RFID 126 tag and patient monitor system 100 are disclosed with reference to their preferred embodiments, the disclosure is not intended to be limited thereby. Rather, a skilled artisan will recognize from the disclosure herein a number of alternatives. For example, the tag reader 470 may allow reading of data only and may or may not have user interface 476. There are a wide variety of mechanisms that may be considered for connecting the RFID tag 126 with a patient, both physically and associatively. Physically, as mentioned above, dog tags, bracelets, bandages, and the like may all help reduce the likelihood of the RFID tag being lost. Associatively, some RFID tags may electronically store identifying patient characteristics, such as for example, patient's name, social security number, physical characteristics, such as hair and eye color, race, and the like. In other embodiments, the RFID tags, such as the RFID bracelets, may have patient identifying information written on the bracelet or other physical surface.

An alternative embodiment is also contemplated wherein the RFID tags store an identification number and patient readings are associated with the identification number and stored in memory located on the patient monitor or on memory accessible via a wired or wireless network, such as a LAN, WAN, peer-to-peer wired or wireless network, or the internet. An alternative embodiment such as this may reduce the complexity of the RFID tags by reducing the size of the information element required or excluding features necessary to allow writing data to the information element. An embodiment utilizing internet access may provide an additional advantage when patients are relocated among hospitals or from a hospital environment, see issues meeting triage center to a hospital.

Additionally, other combinations, omissions, substitutions, and modifications will be apparent to the skilled artisan in view of the disclosure herein. For example, the RFID tags may comprise straightforward unique ID's and the portable instruments could track patient data corresponding to the unique ID's. Once at a central location, the data may advantageously be centralized or access to the data be centralized in order for other monitors to match up more recent data with originally or earlier measured data for caregiver review. Accordingly, the present disclosure is not intended to be limited by the reaction of the preferred embodiments, but is to be defined by reference to the appended claims.

Additionally, all publications, patents, and patent applications mentioned in this specification are herein incorporated by reference to the same extent as if each individual publication, patent, or patent application was specifically and individually indicated to be incorporated by reference.

What is claimed is:

1. A patient monitoring system, comprising:
a RFID tag configure to being associated with a patient and comprising an information element and a radio frequency tag antenna configured to transmit radio signals indicative of data stored in the information element; and
a portable patient monitor comprising (i) one or more sensors configured to output physiological data indicative of light attenuated by body tissue of the patient, (ii) a radio frequency antenna configured to receive signals from the RFID tag, and (iii) a monitor unit configured to communicate with the RFID tag through the radio frequency antenna of the monitor, and configured to communicate with the sensors to receive the physiological data and to process the data to determine one or more physiological characteristics of the patient.

2. The patient monitoring system of claim 1, wherein the monitor unit is also configured to display information responsive to the determined one or more physiological parameters of the patient.

3. The patient monitoring system of claim 1, wherein the monitor unit is also configured to transmit information indicative of the determined one or more physiological parameters of the patient to the information element of the tag through the antenna of the monitor and the tag.

4. The patient monitoring system of claim 3, wherein the monitor unit is also configured to transmit updated information indicative of later determined one or more physiological parameters of the patient to the information element of the tag.

5. The patient monitoring system of claim 1, wherein the RFID tag comprises a passive radio frequency identification tag.

6. The patient monitoring system of claim 1, wherein the RFID tag comprises a power source.

7. A pulse oximeter processing unit, comprising:
a portable housing including an antenna configured to communicate with a RFID tag;
a processor configured to receive signals indicative of physiological parameters acquired from a detector detecting light attenuated by body tissue of a patient, the processor also configured to process the received signals and to receive information from said RFID tag capable of identifying the patient; and
a display configured to display data indicative of the processed signals.

8. A patient-wearable RFID tag, comprising:
a base;
an attachment mechanism configured to maintain the base in proximity to a wearer's body when attached;
a memory associated with the base and capable of storing patient data, the patient data responsive to measured physiological information; and
a radio frequency tag antenna communicating with the memory to broadcast the patient data to a patient monitor.

9. The patient-wearable RFID tag of claim 6, wherein the attachment mechanism comprises a flexible loop suitable for placement around a neck or limb of the patient.

10. The patient-wearable RFID tag of claim 6, wherein the patient-wearable RFID tag comprises a bracelet.

11. The patient-wearable RFID tag of claim 6, wherein the patient-wearable RFID comprises a military-style dog tag.

12. A method for triaging patients, comprising:
attaching to a patient an RFID tag including memory storing identification information capable of uniquely identifying the patient;
acquiring data responsive to light attenuated by body tissue of the patient;
determining physiological information about the patient by processing the acquired data; and
associating at least a portion of the physiological information with the identification information.

13. The method of claim 13, wherein the associating comprises storing the at least said portion of said physiological information on the memory of the RFID tag.

14. The method of claim 13, wherein the associating comprises storing the at least said portion of said physiological information and the identification information on a memory of a patient monitor.
